(19) United States
(12) Patent Application Publication
(10) Pub. No.: US 2022/0293898 A1
(43) Pub. Date: Sep. 15, 2022

(54) METHOD FOR MANUFACTURING CARBON FIBER SHEET, CARBON FIBER SHEET, AND SOLID-STATE BATTERY

(71) Applicant: SEIKO EPSON CORPORATION, Tokyo (JP)

(72) Inventors: Satomi YOSHIOKA, Shiojiri (JP); Naotaka HIGUCHI, Suwa-gun Fujimi-machi (JP); Shunichi SEKI, Suwa (JP); Akio ITO, Matsumoto (JP)

(21) Appl. No.: 17/654,245

(22) Filed: Mar. 10, 2022

(30) Foreign Application Priority Data
Mar. 12, 2021 (JP) 2021-040005

(51) Int. Cl. H01M 4/04; H01M 10/0525; H01M 10/0585; H01M 4/62

(52) U.S. Cl. CPC H01M 4/0404; H01M 10/0525; H01M 10/0585; H01M 4/0471; H01M 4/623; H01M 4/625; H01M 2004/021

(57) ABSTRACT

A method for manufacturing a carbon fiber sheet includes a mixing section that mixes a plurality of carbon fibers with a binding material that binds the carbon fibers, a depositing section that deposits a mixture of the carbon fibers and the binding material, and a forming section that forms a fiber sheet by heating a deposit deposited by the depositing section. The forming section includes a heating portion.

The present application is based on, and claims priority from JP Application Serial Number 2021-040005, filed Mar. 12, 2021, the disclosure of which is hereby incorporated by reference herein in its entirety.

### BACKGROUND

### 1. Technical Field

The present disclosure relates to a method for manufacturing a carbon fiber sheet, a carbon fiber sheet, and a solid-state battery.

### 2. Related Art

In recent years, various electrode materials and various methods for manufacturing electrodes have been proposed for the purpose of improving current load characteristics of lithium ion batteries.

For example, JP-A-2010-238575 discloses a method for manufacturing an electrode for lithium ion batteries. The method includes preparing a dispersion containing fine fibrous carbon having a diameter of less than 100 nm in the form of short fibers, fibrous carbon having a diameter of 100 nm or more, and/or non-fibrous conductive carbon; preparing an electrode coating dispersion by mixing the dispersion with an active material; and applying the electrode coating dispersion.

Japanese Patent No. 5,580,910 discloses a method for manufacturing an electrode. The method includes mixing electrode components containing two types of carbon fibers having different fiber diameters in the form of carbon nanofibers in a dry mode, adding a liquid medium, performing kneading, and forming a sheet.

Furthermore, Japanese Patent No. 5,804,208 discloses a method for manufacturing an all-solid-state battery in which the electronic conductivity in an in-plane direction of an electrode layer or a current collector layer can be increased by incorporating a plurality of conductors, oriented substantially perpendicularly to a stacking direction, in the form of short fibers in the electrode layer or current collector layer in the all-solid-state battery so that the battery capacity can be enhanced.

However, chopped carbon fibers are poorly dispersible in a liquid medium. Therefore, there is a problem in that fiber components are likely to aggregate in wet application in the manufacturing methods described in the above documents, no uniform coating film is obtained, and electrode characteristics are insufficient.

### SUMMARY

Accordingly, the present disclosure provides forming an electrode with high density and low electrical resistance in such a manner that an electrode film is formed by forming chopped carbon fibers into a sheet by a dry method.

According to an aspect of the present disclosure, a method for manufacturing a carbon fiber sheet includes a mixing section that mixes a plurality of carbon fibers with a binding material that binds the carbon fibers, a depositing section that deposits a mixture of the carbon fibers and the binding material, and a forming section that forms a fiber sheet by heating a deposit deposited by the depositing section. The forming section includes a heating portion.

In the method for manufacturing a carbon fiber sheet, the depositing section may include a nonwoven fabric sheet and may apply tension and vibration to the nonwoven fabric sheet.

In the method for manufacturing a carbon fiber sheet, the depositing section may include a sheet composed of a metal mesh or a membrane filter.

In the method for manufacturing a carbon fiber sheet, the depositing section may include a sheet composed of metal foil, a metal film, a metal plate, or a metal-coated substrate.

In the method for manufacturing a carbon fiber sheet, the temperature of the heating portion may be 150° C. or higher.

The method for manufacturing a carbon fiber sheet may further include applying a microwave.

In the method for manufacturing the carbon fiber sheet, the binding material may contain polyvinylidene fluoride.

In the method for manufacturing a carbon fiber sheet, the carbon fibers may have an average fiber diameter of 1 nm to 1,000 nm and an average fiber length of 1 μm to 100 μm.

A carbon fiber sheet is manufactured by the method for manufacturing a carbon fiber sheet.

A solid-state battery includes the carbon fiber sheet.

### BRIEF DESCRIPTION OF THE DRAWINGS

FIG. 1 is a conceptual view of a solid-state battery including a carbon fiber sheet according to an embodiment.

FIG. 2 is a schematic view of an example of an apparatus for manufacturing a carbon fiber sheet according to an embodiment.

FIG. 3 is a conceptual view of a solid-state battery including a carbon fiber sheet according to an embodiment.

FIG. 4 is a conceptual view of a solid-state battery including a carbon fiber sheet according to an embodiment.

### DESCRIPTION OF EXEMPLARY EMBODIMENTS

Some embodiments of the present disclosure are described below with reference to the accompanying drawings.

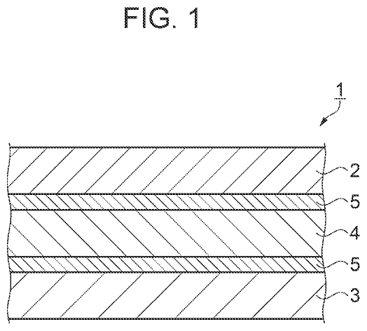

As shown in FIG. 1, a solid-state battery 1 according to an embodiment is composed of a positive electrode layer 2, a negative electrode layer 3, and a solid electrolyte layer 4 and includes a carbon fiber sheet layer 5 interposed between the positive electrode layer 2 and the solid electrolyte layer 4 and a carbon fiber sheet layer 5 interposed between the negative electrode layer 3 and the solid electrolyte layer 4. In the solid-state battery 1, which is configured as described above, electrode materials such as the positive electrode layer 2, the negative electrode layer 3, and the carbon fiber sheet layer 5 are disposed, and carbon fibers contained in the carbon fiber sheet layers 5, which are interposed between the positive and negative electrode layers 2 and 3 and the solid electrolyte layer 4, ensure a lithium ion path. Thus, the supply of electrons is good, and charge/discharge characteristics can be enhanced.

Carbon Fibers

The carbon fibers (fibrous carbon), such as fibrous carbon, are contained in the electrode materials in the solid-state battery 1 according to this embodiment. The carbon fibers, which are contained in the electrode materials, are preferably made of graphitizable carbon. Graphitizable carbon is a carbon material that is likely to form a graphite structure with three-dimensional stacking regularity when subjected to heat treatment at a high temperature of 2,500° C. or higher. Graphitizable carbon is also called soft carbon. Examples of graphitizable carbon include petroleum coke, coal pitch coke, polyvinyl chloride, and a 3,5-dimethylphenol-formaldehyde resin.

In particular, a compound which is called a mesophase pitch and which can form an optically anisotropic phase (liquid crystal phase) in a molten state or a mixture containing the compound is preferable because high crystallinity and high conductivity are expected. Examples of mesophase pitch include petroleum-based mesophase pitch obtained by a method mainly including hydrogenating and heat-treating petroleum residue or a method mainly including hydrogenating, heat-treating, and solvent-extracting petroleum residue; coal-based mesophase pitch obtained by a method mainly including hydrogenating and heat-treating coal tar pitch or a method mainly including hydrogenating, heat-treating, and solvent-extracting coal tar pitch; and synthetic liquid-crystal pitch obtained by the polycondensation of an aromatic hydrocarbon such as naphthalene, alkylnaphthalene, or anthracene, serving as a raw material, in the presence of a superacid (for example, HF, BF₃, or the like). Among these, the synthetic liquid-crystal pitch is more preferable because the synthetic liquid-crystal pitch contains no impurities.

The average fiber diameter of the carbon fibers according to this embodiment is in the range of 1 nm to 1,000 nm. The average fiber diameter is a value measured from a photographic image taken at 2,000× magnification with a field emission-scanning electron microscope or a photographic image taken at 2,000,000× magnification with a transmission electron microscope. The average fiber diameter of the carbon fibers is preferably in the range of more than 230 nm to 600 nm, more preferably in the range of more than 250 nm to 500 nm, and further more preferably in the range of more than 250 nm to 400 nm.

The carbon fibers according to this embodiment have a linear structure. Herein, the term “linear structure” means that the degree of branching is 0.01 branches/μm or less. The term “branching” refers to a granular portion in which a portion other than an end portion of a carbon fiber is combined with another carbon fiber and means that the major axis of a carbon fiber branches in the middle thereof and that the major axis of a carbon fiber has a dendritic minor axis.

The average fiber length of the carbon fibers according to this embodiment is preferably in the range of 1 μm to 100 μm and more preferably in the range of 1 μm to 50 μm. As the average fiber length of the carbon fibers is larger, the conductivity in an electrode, the strength of an electrode, and the retentivity of an electrolytic solution increase, which is preferable. However, when the average fiber length of the carbon fibers is too large, there is a problem in that the dispersibility of the carbon fibers in an electrode is impaired. Therefore, the average fiber length of the carbon fibers is preferably in the above range.

### Binding Material

A binding material for the carbon fibers according to this embodiment is preferably a thermoplastic resin. The resin may be in the form of particles or fibers. Polyester (PE), polyacrylonitrile (PAN), polycarbonate (PC), polyether ether ketone (PEEK), polyamideimide (PAI), polyphenylene sulfide (PPS), polyetherimide (PEI), polyvinylidene fluoride (PVdF), and the like can be given as examples of the thermoplastic resin.

The glass transition temperature of the thermoplastic resin according to this embodiment is preferably −50° C. or higher. In order to enable the fluidity thereof to be maintained at a heating temperature during sheet forming, the glass transition temperature is preferably −50° C. to 80° C.

The fiber length of the thermoplastic resin according to this embodiment is preferably 2 mm or more and more preferably 3 mm or more. This increases the number of contacts with the carbon fibers to exhibit bonding force.

The average particle size of the thermoplastic resin is preferably 0.5 μm or more and more preferably 0.8 μm or more. This increases the number of contacts with the carbon fibers to exhibit bonding force.

### Solid-State Battery

When the positive electrode layer 2 of the solid-state battery 1 according to this embodiment is prepared, a positive electrode active material that can be used in the solid-state battery 1 can be appropriately used as an active material.

Layered active materials such as lithium cobaltate (LiCoO₂) and lithium nickelate (LiNiO₂), olivine-type active materials such as olivine-type lithium iron phosphate (LiFePO₄), spinel-type active materials such as spinel-type lithium manganate (LiMn₂O₄), and the like can be given as examples of such a positive electrode active material. The positive electrode active material may be in the form of, for example, particles or a thin film. The average particle size (D50) of the positive electrode active material is preferably, for example, 1 nm to 100 μm and more preferably 10 nm to 30 μm. The content of the positive electrode active material in the positive electrode layer 2 is not particularly limited and is preferably, for example, 20% to 90% on a mass basis.

A form in which the increase in resistance of a battery can be easily prevented can be obtained if a high-resistance layer is unlikely to be formed at an interface between the positive electrode active material in the positive electrode layer 2 and a solid electrolyte in the solid electrolyte layer 4. From such a viewpoint, the positive electrode active material is preferably coated with a lithium ion-conducting oxide.

For example, an oxide represented by the general formula LiₓAO_{y} (A is the element B, C, Al, Si, P, S, Ti, Zr, Nb, Mo, Ta, or W and x and y are positive numbers) can be cited as the lithium ion-conducting oxide for coating the positive electrode active material. In particular, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, and the like can be given as examples. The lithium ion-conducting oxide may be a composite oxide. The composite oxide, which is used to coat the positive electrode active material, may be any combination of the above lithium ion-conducting oxides and, for example, Li₄SiO₄—Li₃BO₃ and Li₄SiO₄—Li₃PO₄ can be cited.

When the surface of the positive electrode active material is coated with the lithium ion-conducting oxide, the lithium ion-conducting oxide may cover at least a portion of the positive electrode active material or may cover the whole of the positive electrode active material. The thickness of the lithium ion-conducting oxide covering the positive electrode active material is preferably, for example, 0.1 nm to 100 nm and more preferably 1 nm to 20 nm. The thickness of the lithium ion-conducting oxide can be measured using, for example, a transmission electron microscope (TEM) or the like.

When the negative electrode layer 3 of the solid-state battery 1 according to this embodiment is prepared, a negative electrode active material that can be used in the solid-state battery 1 can be appropriately used as an active material.

For example, carbon active materials, oxide active materials, metal active materials, and the like can be cited as such a negative electrode active material. The carbon active materials are not particularly limited as long as they contain carbon and, for example, meso-carbon microbeads (MCMBs), highly oriented pyrolytic graphite (HOPG), hard carbon, soft carbon, and the like can be cited. For example, Nb₂O₅, Li₄Ti₅O₁₂, SiO, and the like can be cited as the oxide active materials. For example, In, Al, Si, Sn, and the like can be cited as the metal active materials. The negative electrode active material used may be a lithium-containing metal active material. The lithium-containing metal active material is not particularly limited as long as it is an active material containing at least Li. The lithium-containing metal active material may be metallic Li or a Li alloy. For example, an alloy containing Li and at least one of In, Al, Si, or Sn can be cited as the Li alloy. The negative electrode active material may be in the form of, for example, particles or a thin film. The average particle size (D50) of the negative electrode active material is preferably, for example, 1 nm to 100 μm and more preferably 10 nm to 30 μm. The content of the negative electrode active material in the negative electrode layer 3 is not particularly limited and is preferably, for example, 20% to 99% on a mass basis.

The solid electrolyte layer 4 according to this embodiment may contain a known solid electrolyte that can be used in the solid-state battery 1.

Oxide-based amorphous solid electrolytes such as Li₂O—B₂O₃—P₂O₅ and Li₂O—SiO₂; sulfide-based amorphous solid electrolytes such as Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, and Li₃PS₄; LiI; Li₃N; crystalline oxides and oxynitrides such as Li₅La₃Ta₂O₁₂, Li₇La₃Zr₂O₁₂, Li₆BaLa₂Ta₂O₁₂, Li₃PO_{(4-3/2w)}N_{w} (W<1), and Li_{3.6}Si_{0.6}P_{0.4}O₄; and the like can be given as examples of such a solid electrolyte. The solid electrolyte used is preferably a sulfide solid electrolyte from a viewpoint that an electrode, likely to enhance the performance of the solid-state battery 1, for solid-state batteries can be manufactured.

In this embodiment, a known binder that can be used in the positive electrode layer 2 or negative electrode layer 3 of the solid-state battery 1 can be appropriately used as a binder that binds an active material in an electrode. Acrylonitrile-butadiene rubber (ABR), butadiene rubber (BR), polyvinylidene fluoride (PVdF), fluorine-containing rubber, styrene-butadiene rubber (SBR), and the like can be given as examples of such a binder. In this embodiment, from the viewpoint of reactivity with an electrolyte, butadiene rubber that has been hydrogenated such that almost all double bonds are eliminated is preferably used and a binder containing a functional group is preferably used.

A solvent used in this embodiment is a good or poor solvent, unreactive with the solid electrolyte, for binders. A known organic solvent can be appropriately used as such a solvent. A solvent having a solubility of about 0.1% by weight to less than 2% by weight relative to the good solvent for binders can be used as such a poor solvent for binders. In this embodiment, the good solvent for binders and the poor solvent for binders preferably have a water content of 100 ppm or less from the viewpoint of the deterioration of an electrolyte.

In this embodiment, a slurry-like electrode composition is prepared by kneading the active material, the solid electrolyte, the binder, the solvent, and a conductive material that enhances conductivity and an electrode can be prepared using the slurry-like electrode composition. Carbon materials such as vapor-grown carbon fibers, acetylene black (AB), Ketjenblack (KB), carbon nanotubes (CNTs), and carbon nanofibers (CNFs) and metal materials capable of withstanding environments in which solid-state batteries are used can be given as examples of a conductive material that can be used in this embodiment.

A coating step in this embodiment may be a mode in which a positive electrode current collector or a negative electrode current collector is coated with the slurry-like electrode composition. In this embodiment, a positive electrode current collector and negative electrode current collector that can be used as current collectors of the solid-state battery 1 can be appropriately used. Such a positive electrode current collector and negative electrode current collector can be made from a metal material containing one or more elements selected from the group consisting of Cu, Ni, Al, V, Au, Pt, Mg, Fe, Ti, Co, Cr, Zn, Ge, and In. The positive electrode current collector and the negative electrode current collector may be in the form of, for example, foil.

### Carbon Fiber Sheet

A method for manufacturing a carbon fiber sheet according to this embodiment is described.

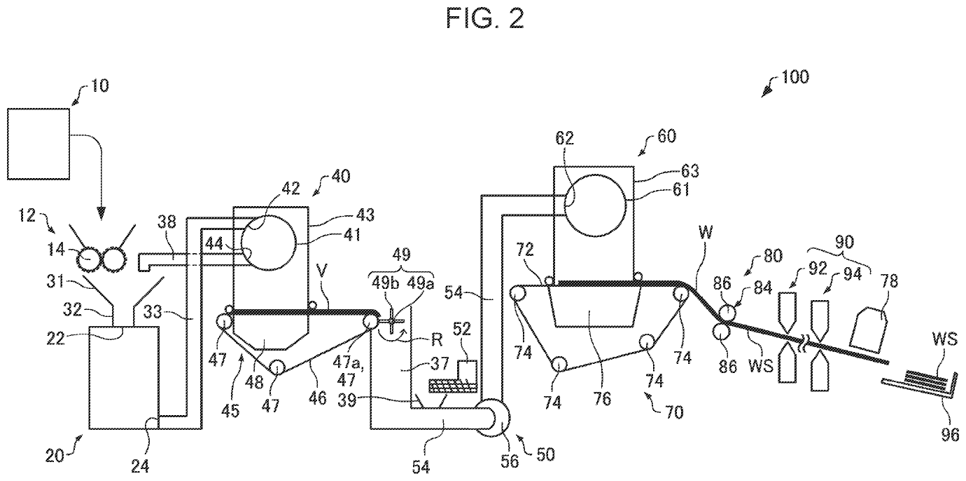

FIG. 2 is a schematic view of a fiber sheet-manufacturing apparatus 100 according to this embodiment. The fiber sheet-manufacturing apparatus 100 is an apparatus for manufacturing the carbon fiber sheet and is used to manufacture a fiber sheet WS corresponding to the carbon fiber sheet.

As shown in FIG. 2, the fiber sheet-manufacturing apparatus 100 includes a supply section 10, a rough crushing section 12, a disintegration section 20, a screening section 40, a first web-forming section 45, a rotator 49, a mixing section 50, a depositing section 60, a second web-forming section 70, a fiber sheet-forming section 80, a cutting section 90, and a liquid-applying section 78.

Among these sections, the rough crushing section 12, the disintegration section 20, the screening section 40, and the first web-forming section 45 are sections included depending on properties of raw materials as required and are not essential. If properties of a raw material prepared in advance meet necessary conditions, then the supply section 10 may be directly coupled to the mixing section 50 or the depositing section 60.

The supply section 10 supplies a feedstock to the rough crushing section 12. The supply section 10 is, for example, an automatic input section for continuously inputting the feedstock to the rough crushing section 12. The feedstock supplied to the rough crushing section 12 may be one containing the carbon fibers.

The rough crushing section 12 cuts the feedstock supplied by the supply section 10 into small pieces in gas such as the atmosphere (air). The small pieces are, for example, several centimeters square pieces. In the illustrated example, the rough crushing section 12 includes rough crushing blades 14 and can cut the input feedstock with the rough crushing blades 14. The rough crushing section 12 used is, for example, a shredder. The feedstock cut by the rough crushing section 12 is received in a hopper 31 and is then transferred (transported) to the disintegration section 20 through a pipe 32.

The disintegration section 20 disintegrates the feedstock cut by the rough crushing section 12. Herein, the term “disintegrate” means that a feedstock (a material to be disintegrated) containing a plurality of bound fibers is disentangled one by one.

The disintegration section 20 performs disintegration in a dry mode. Performing treatment such as disintegration in gas such as air, rather than liquid (a wet mode in which material is dissolved into slurry) such as water, is referred to as a dry mode. In this embodiment, the disintegration section 20 used is an impeller mill. The disintegration section 20 has a function of generating a gas flow that sucks the feedstock and discharges disintegrated material. This enables the disintegration section 20 to suck the feedstock from an inlet 22 together with a gas flow by means of a gas flow generated by the disintegration section 20, to disintegrate the feedstock, and to transport the disintegrated material to an outlet 24. The disintegrated material having passed through the disintegration section 20 is transferred to the screening section 40 through a pipe 33. A gas flow for transporting the disintegrated material from the disintegration section 20 to the screening section 40 may be the gas flow generated by the disintegration section 20 or a gas flow generated by a gas flow generator such as a blower.

The screening section 40 receives the disintegrated material disintegrated in the disintegration section 20 from an inlet 42 and screens the disintegrated material depending on the length of fibers. The screening section 40 includes a drum portion 41 and a housing portion 43 that houses the drum portion 41. The drum portion 41 used is, for example, a sieve. The drum portion 41 includes a net (filter, screen) and can separate fibers or particles (those passing through the net, first screened fraction) smaller in size than openings of the net and fibers, undisintegrated pieces, or lumps (those not passing through the net, second screened fraction) larger in size than the openings of the net. For example, the first screened fraction is transferred to the mixing section 50 through a pipe 37. The second screened fraction is returned to the disintegration section 20 from an outlet 44 through a pipe 38. In particular, the drum portion 41 is a cylindrical sieve rotationally driven with a motor. The net of the drum portion 41 used is, for example, a metal gauze, an expanded metal obtained by expanding a slit metal plate, or a punching metal obtained by forming holes in a metal plate with a press or the like.

The first web-forming section 45 transports the first screened fraction having passed through the screening section 40 to the mixing section 50. The first web-forming section 45 includes a mesh belt 46, tension rollers 47, and a suction portion (suction mechanism) 48.

The suction portion 48 can suck the first screened fraction which has passed through openings of the screening section 40 (openings of the net) and which has been dispersed in air onto the mesh belt 46. The first screened fraction is deposited on the moving mesh belt 46 to form a web V. The basic configuration of the mesh belt 46, the tension rollers 47, and the suction portion 48 is substantially the same as that of a mesh belt 72, tension rollers 74, and suction mechanism 76 of the second web-forming section 70 as described below.

The web V passes through the screening section 40 and the first web-forming section 45 and is thereby formed in such a state that the web V contains much air and is soft and bulgy. The web V deposited on the mesh belt 46 is input to the pipe 37 and is transported to the mixing section 50.

The rotator 49 can cut the web V before the web V is transported to the mixing section 50. In the illustrated example, the rotator 49 includes a base portion 49a and protruding portions 49b protruding from the base portion 49a. The protruding portions 49b have, for example, a plate shape. In the illustrated example, the number of the protruding portions 49b is four and the four protruding portions 49b are arranged at equal intervals. The base portion 49a rotates in a direction R and therefore the protruding portions 49b can rotate about the base portion 49a. For example, the change in amount of the disintegrated material supplied to the depositing section 60 per unit time can be reduced in such a manner that the web V is cut with the rotator 49.

The rotator 49 is disposed in the vicinity of the first web-forming section 45. In the illustrated example, the rotator 49 is disposed in the vicinity of a tension roller 47a (beside the tension roller 47a) located downstream in the path of the web V. The rotator 49 is disposed at a position where the protruding portions 49b can come into contact with the web V and where the protruding portions 49b do not come into contact with the mesh belt 46 on which the web V is deposited. The shortest distance between the protruding portions 49b and the mesh belt 46 is, for example, 0.05 mm to 0.5 mm.

The mixing section 50 mixes the first screened fraction having passed through the screening section 40 (the first screened fraction transported from the first web-forming section 45) with an additive containing the binding material. The mixing section 50 includes an additive-supplying portion 52 that supplies the additive, a pipe 54 through which the first screened fraction and the additive are transported, and a blower 56. In the illustrated example, the additive is supplied to the pipe 54 from the additive-supplying portion 52 through a hopper 39. The pipe 54 connects to the pipe 37.

In the mixing section 50, a gas flow is generated with the blower 56 and the first screened fraction and the additive can be transported in the pipe 54 with the first screened fractions and the additive being mixed together. A mechanism that mixes the first screened fraction and the additive together is not particularly limited and may be one that performs stirring by means of blades rotating at high speed or one that uses the rotation of a container like a V-type mixer.

The additive-supplying portion 52 used is such a screw feeder as shown in FIG. 2 or a disk feeder, which is not shown. The additive supplied from the additive-supplying portion 52 contains the above-mentioned binding material. A plurality of fibers are unbound at the point in time when the binding material is supplied. When the binding material passes through the fiber sheet-forming section 80, which is described below, the binding material is partially melted and binds the carbon fibers in a surface region of the fiber sheet WS.

The depositing section 60 receives a mixture having passed through the mixing section 50 from an inlet 62, disentangles intertwined fibers, and drops the fibers in air with the fibers being dispersed. This enables the depositing section 60 to uniformly deposit the mixture on the second web-forming section 70.

The depositing section 60 includes a drum portion 61 and a housing portion 63 that houses the drum portion 61. The drum portion 61 used is, for example, a rotary cylindrical sieve. The drum portion 61 includes a net and drops fibers or particles (those passing through the net) which are contained in the mixture having passed through the mixing section 50 and which are smaller in size than openings of the net. The configuration of the drum portion 61 is the same as the configuration of, for example, the drum portion 41.

The “sieve” of the drum portion 61 need not have a function of screening a specific target. That is, the “sieve” used as the drum portion 61 means a member equipped with a net. The drum portion 61 may drop all of the mixture introduced in the drum portion 61.

The second web-forming section 70 deposits a passing material having passed through the depositing section 60 to form a web W that is a deposit to be converted into the fiber sheet WS. The second web-forming section 70 includes, for example, the mesh belt 72, the tension rollers 74, and the suction mechanism 76.

The mesh belt 72 deposits the passing material having passed through openings of the depositing section 60 (openings of the net) on a forming die while the mesh belt 72 is moving. The mesh belt 72 is tensioned by the tension rollers 74, which are a plurality of rollers, and is configured such that the passing material is unlikely to pass through the mesh belt 72 and air passes through the mesh belt 72. The mesh belt 72 moves so as to revolve due to the rotation of the tension rollers 74. The passing material having passed through the depositing section 60 falls and accumulates continuously while the mesh belt 72 is continuously moving, whereby the web W of the forming die is formed on the mesh belt 72.

The mesh belt 72 may be made of metal, resin, cloth, nonwoven fabric, or the like.

Furthermore, a web can be formed in such a manner that a sheet composed of a metal filter, a membrane filter, a nonwoven fabric (not shown), or the like is attached to the mesh belt 72 and the passing material is deposited on the sheet. In this case, since the carbon fibers contained in the passing material are unlikely to be electrically charged, a main component that is deposited is preferably material unlikely to be electrically charged and is preferably made of, for example, acetate, polyester, paper, aluminium, iron, copper, or silver.

The attached sheet may be metal foil not in the form of mesh, a metal film, a metal plate, a metal-coated substrate, or the like or one that can be used for, for example, electrode materials.

The suction mechanism 76 is disposed under the mesh belt 72 (on the opposite side from the depositing section 60). The suction mechanism 76 can generate a gas flow directed downward (a gas flow directed from the depositing section 60 to the mesh belt 72). The mixture dispersed in air from the depositing section 60 can be sucked on the mesh belt 72 by the suction mechanism 76. This enables the discharge rate from the depositing section 60 to be increased. Furthermore, a downflow can be formed in the fall path of the mixture by the suction mechanism 76, thereby enabling the disintegrated material and the additive to be prevented from being intertwined during falling.

As described above, passing through the depositing section 60 and the second web-forming section 70 (web-forming step) allows the web W to be formed. The web W deposited on the mesh belt 72 is transported to the fiber sheet-forming section 80. The thickness of the web W (deposit) transported to the fiber sheet-forming section 80 is preferably 0.1 mm to 50.0 mm and more preferably 0.2 mm to 30.0 mm. The density of the web W (deposit) is preferably 0.001 g/cm³ to 0.1 g/cm³ and more preferably 0.002 g/cm³ to 0.05 g/cm³.

The fiber sheet-forming section 80 heats the web W deposited on the mesh belt 72 to form the fiber sheet WS. In the fiber sheet-forming section 80, the web W, which is composed of a deposit of the disintegrated material and additive mixed together, is heated, thereby enabling the binding material to be melted.

The fiber sheet-forming section 80 includes a heating portion 84 that heats the web W at 150° C. or higher. The heating portion 84 used is, for example, a heat press or a heating roller (heater roller). The heating portion 84 is described below using an example in which heating rollers (heater rollers) are used. The number of heating rollers in the heating portion 84 is not particularly limited. In the illustrated example, the heating portion 84 includes a pair of heating rollers 86. Since the heating portion 84 is composed of the heating rollers 86, the fiber sheet WS can be formed in such a manner that the web W is continuously transported. The heating rollers 86 are placed such that, for example, the axes of rotation thereof are parallel.

The heating rollers 86 transport the web W with the web W pinched therebetween to form the fiber sheet WS such that the fiber sheet WS has a predetermined thickness. Herein, the pressure applied to the web W by the heating rollers 86 is preferably 0.1 megapascals to 10.0 megapascals and more preferably 0.5 megapascals to 7.0 megapascals.

When the web W is heated, the surface temperature of the heating rollers 86 is appropriately set depending on the glass transition temperature Tg or melting point of resin contained in the binding material. For example, the surface temperature of the heating rollers 86 is 20.0° C. to 250.0° C. and is preferably 25.0° C. to 220.0° C. Setting the surface temperature of the heating rollers 86 in this range enables the surface of the web W (deposit) to be heated in this range.

A method for heating the web W is not limited to the heating rollers 86. The carbon fibers may be bound together by melting the binding material in such a manner that a step of applying a microwave (not shown) is used and the microwave is applied to the web W.

In accordance with the fiber sheet-manufacturing apparatus 100 according to this embodiment, the fiber sheet WS according to this embodiment can be manufactured as described above.

The fiber sheet-manufacturing apparatus 100 according to this embodiment may include a cutting section 90 as required. Referring to FIG. 2, the cutting section 90 is located downstream of the heating portion 84. The cutting section 90 cuts the fiber sheet WS formed by the fiber sheet-forming section 80. The cutting section 90 includes a first cutting portion 92 that cuts the fiber sheet WS in a direction crossing the transport direction of the fiber sheet WS and a second cutting portion 94 that cuts the fiber sheet WS in a direction parallel to the transport direction thereof. The second cutting portion 94 cuts the fiber sheet WS having passed through, for example, the first cutting portion 92.

The fiber sheet-manufacturing apparatus 100 according to this embodiment may include a liquid-applying section 78. Referring to FIG. 2, the liquid-applying section 78 is located downstream of the cutting section 90 and upstream of the discharge section 96. The liquid-applying section 78 can apply water or an organic solvent to the fiber sheet WS. A particular mode of the liquid-applying section 78 is, for example, a mode in which a mist of water or the organic solvent is applied, a mode in which water or the organic solvent is sprayed, a mode in which water or the organic solvent is discharged from an ink jet head and is applied, or the like.

When the fiber sheet-manufacturing apparatus 100 includes the liquid-applying section 78, the fiber sheet WS that is formed can have flexibility. This provides an advantage that formability in the next and subsequent steps in electrode manufacture improves.

In the example shown in FIG. 2, the liquid-applying section 78 is located downstream of the cutting section 90. If the liquid-applying section 78 is located downstream of the heating portion 84, substantially the same effect as above can be obtained. That is, the liquid-applying section 78 may be located downstream of the heating portion 84 and upstream of the cutting section 90.

### EXAMPLES

For the manufacture of a carbon fiber sheet using the fiber sheet-manufacturing apparatus 100, the present disclosure is further described below in detail with reference to examples and modifications.

### Example 1

VGCG-S (produced by Showa Denko K.K., a diameter of 100 nm, a fiber length of 10 μm) that was a carbon fiber material and polyvinylidene fluoride (a particle size of 5 μm) that was a binding material were mixed together and were supplied to the fiber sheet-manufacturing apparatus 100 and the mixed materials were deposited on a nonwoven fabric sheet (made of polyester) in such a manner that the mixed materials were sucked with the suction mechanism 76, whereby a web was formed. By applying tension and vibration to the nonwoven fabric sheet, carbon fibers were oriented in a tensile direction (transport direction) of the nonwoven fabric sheet. Furthermore, a carbon fiber sheet was formed through a heating-pressurizing step.

### Example 2

In this example, a carbon fiber sheet was formed in such a manner that the mixed materials were deposited on a metal mesh, made of aluminium, used instead of the nonwoven fabric sheet of Example 1. The deposit on the metal mesh was treated at 210° C., which was higher than that in the above-mentioned embodiment or example, to thermally fuse the carbon fibers, thereby enabling the carbon fiber sheet to be formed such that the carbon fiber sheet had high durability.

### Example 3

In this example, a carbon fiber sheet was formed in such a manner that the deposit on the metal mesh of Example 2 was overlaid with a membrane filter and the deposit of the mixed materials was pinched between the metal mesh and the membrane filter. This enabled the deposit to be prepared such that the separation of carbon fibers was minimized and enabled the carbon fiber sheet to be efficiently formed.

### Example 4

In this example, a carbon fiber sheet was formed in such a manner that the mixed materials were deposited on metal foil, made of aluminium, used instead of the nonwoven fabric sheet of Example 1. The mixed materials, which contained carbon fibers, were deposited on the metal foil by free fall without being sucked by the suction mechanism 76 and the carbon fiber sheet was formed through a heating-pressurizing step. This enabled the carbon fiber sheet to be formed such that the carbon fiber sheet had higher density as compared to Example 1.

### Example 5

### Addition of High-Temperature Firing Process

In this example, the carbon fiber sheet prepared in Example 2 was further fired at high temperature. The firing temperature was, for example, 1,000° C. to 3,000° C. In this manner, the carbon fiber sheet could be prepared such that electron mobility was increased by forming crosslinks from carbon and internal resistance was further reduced.

### Example 6

### Change of Forming Process

In this example, a carbon fiber sheet was formed in such a manner that the carbon fiber sheet prepared in Example 2 was irradiated with microwaves such that the binding material was melted, followed by roller heating. Carbon fibers themselves generated heat by the application of microwaves and resin was melted; hence, the carbon fibers could be thermally fused in a short time. In particular, a thick carbon fiber sheet with low density depends on heat conduction from a surface and therefore it takes a long time to heat the inside of the carbon fiber sheet. Therefore, this suggests that a method in which microwaves are applied is effective.

### Example 7

### Preparation of Electrode Layer

In this example, the following example is described with reference to FIG. 1: an example of a solid-state battery manufactured by a known method (JP-A-2013-118143) using the carbon fiber sheets formed in Examples 1 to 5 as electrode layers. That is, a surface of a positive electrode current collector was coated with a slurry-like positive electrode composition (electrode composition) prepared using a positive electrode active material and a positive electrode layer 2 including the positive electrode current collector and the positive electrode composition was prepared through a drying step. A surface of a negative electrode current collector was coated with a slurry-like negative electrode composition (electrode composition) prepared using a negative electrode active material and a negative electrode layer 3 including the negative electrode current collector and the negative electrode composition was prepared through a drying step.

The carbon fiber sheets prepared in the above examples were stacked on surfaces of the positive electrode layer 2 and the negative electrode layer 3, whereby carbon fiber sheet layers 5 are formed. A solid electrolyte layer 4 was formed through a step of applying a slurry-like electrolyte composition containing a solid electrolyte. The positive electrode layer 2, the negative electrode layer 3, and the solid electrolyte layer 4 were stacked such that the solid electrolyte layer 4 was interposed between the positive electrode layer 2 and/or the negative electrode layer 3 with one of the carbon fiber sheet layers 5 therebetween, followed by steps such as pressing with a predetermined pressure of about 400 MPa and sealing in an enclosure under reduced pressure, whereby a solid-state battery 1 was manufactured.

The solid-state battery 1 manufactured in this example was a solid-state battery which included electrodes having high density and low electrical resistance and which had comparable electrode characteristics because carbon fiber sheets formed from chopped carbon fibers by a dry method were placed as electrode layers.

### Modifications

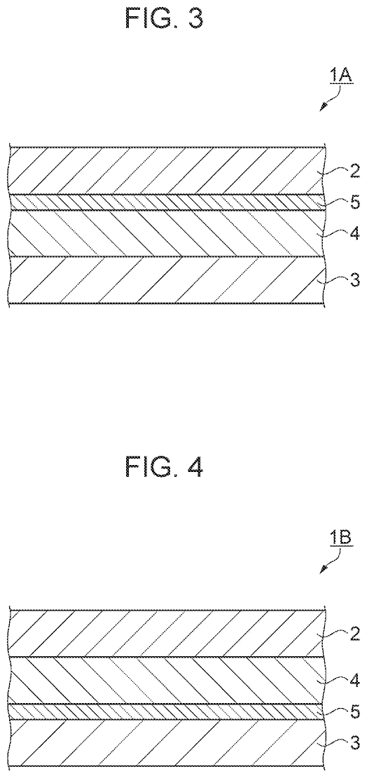

FIGS. 3 and 4 show modifications of the present disclosure. As shown in FIG. 3, a solid-state battery lA includes a positive electrode layer 2, a solid electrolyte layer 4, a carbon fiber sheet layer 5 interposed therebetween, and a negative electrode layer 3 in contact with the solid electrolyte layer 4. As shown in FIG. 4, a solid-state battery 1B includes a negative electrode layer 3, a solid electrolyte layer 4, a carbon fiber sheet layer 5 interposed therebetween, and a positive electrode layer 2 in contact with the solid electrolyte layer 4.

As described above, a solid-state battery which includes electrodes having high density and low electrical resistance and which has comparable electrode characteristics can be manufactured in such a manner that a carbon fiber sheet layer 5 is provided on either of a positive electrode layer 2 and a negative electrode layer 3.

In the present disclosure, a carbon fiber sheet layer is referred to as a layer even when a positive electrode layer, a negative electrode layer, and a solid electrolyte layer are present together without forming any layer in a strict sense.

The present disclosure is not limited to the above embodiments including the examples and the modifications and various modifications can be made. The present disclosure includes substantially the same configurations as configurations described in the embodiments, that is, for example, configurations identical in function, method, and result or configurations identical in object and effect. The present disclosure includes configurations obtained by replacing nonessential portions of configurations described in the embodiments. The present disclosure includes configurations that provide the same advantageous effects as those of configurations described in the embodiments or configurations capable of achieving the same object. Furthermore, the present disclosure includes configurations obtained by adding a known technique to configurations described in the embodiments.

What is claimed is:

1. A method for manufacturing a carbon fiber sheet, comprising:
a mixing section that mixes a plurality of carbon fibers with a binding material that binds the carbon fibers;
a depositing section that deposits a mixture of the carbon fibers and the binding material; and
a forming section that forms a fiber sheet by heating a deposit deposited by the depositing section, wherein
the forming section includes a heating portion.

2. The method for manufacturing a carbon fiber sheet according to claim 1, wherein the depositing section includes a nonwoven fabric sheet and applies tension and vibration to the nonwoven fabric sheet.

3. The method for manufacturing a carbon fiber sheet according to claim 1, wherein the depositing section includes a sheet composed of a metal mesh or a membrane filter.

4. The method for manufacturing a carbon fiber sheet according to claim 1, wherein the depositing section includes a sheet composed of metal foil, a metal film, a metal plate, or a metal-coated substrate.

5. The method for manufacturing a carbon fiber sheet according to claim 1, wherein a temperature of the heating portion is 150° C. or higher.

6. The method for manufacturing a carbon fiber sheet according to claim 1, further comprising applying a microwave.

7. The method for manufacturing a carbon fiber sheet according to claim 1, wherein the binding material contains polyvinylidene fluoride.

8. The method for manufacturing a carbon fiber sheet according to claim 1, wherein the carbon fibers have an average fiber diameter of 1 nm to 1,000 nm and an average fiber length of 1 μm to 100 μm.

9. A carbon fiber sheet manufactured by the method for manufacturing a carbon fiber sheet according to claim 1.

10. A solid-state battery comprising the carbon fiber sheet according to claim 9.
